(19) United States
(12) Patent Application Publication
(10) Pub. No.: US 2012/0293860 A1
(43) Pub. Date: Nov. 22, 2012

(54) INTERNAL REFLECTION ELEMENTS HAVING INCREASED ENERGY THROUGHPUT FOR ATTENUATED TOTAL REFLECTANCE SPECTROSCOPY

(75) Inventors: Kent Gundlach, Madison, WI (US); Julie Capodagli, Madison, WI (US)

(73) Assignee: Pike Technologies

(21) Appl. No.: 13/111,021

(22) Filed: May 19, 2011

(51) Int. Cl. G02B 17/08; G02B 1/12

(52) U.S. Cl. 359/351; 427/164

(57) ABSTRACT

Disclosed are internal reflection elements (IREs) for attenuated total reflectance spectroscopy with an IR beam. The IREs include a lens element having opposed first and second surfaces converging at the edges of the lens element and a layer of a reflective material coated over the first surface. The layer defines an entrance aperture through which an IR beam enters into the lens element and an exit aperture through which the IR beam exits the lens element. The entrance aperture is configured to block a fraction of the IR beam from entering the lens element. The IREs are capable of exhibiting high energy throughputs and providing better quality IR spectra.

### BACKGROUND

Attenuated total reflectance (ATR) spectroscopy involves measuring the changes that occur in a totally internally reflected infrared (IR) beam when the beam comes into contact with a sample. In particular, the sample is placed against the surface of an infrared transmitting crystal having a higher index of refraction than the sample. These crystals may be referred to as internal reflection elements (IREs). An IR beam is directed into the IRE such that it is totally internally reflected at the interface between the sample and the IRE. The sample may absorb some of the energy of the IR beam via an evanescent wave generated at the interface. The reflected radiation exits the IRE and is passed to a detector, generating an IR spectrum. To date, the best conventional IREs are designed to make use of all of the light from an IR source directed at the IRE and to focus all of this light onto the interface between the sample and the IRE. These IREs are thought to have some of the highest energy throughputs possible because they deliver as much of the available light from the IR source to the sample as possible. However, because energy throughput affects the quality of the resulting IR spectrum, even higher energy throughputs are desirable.

### SUMMARY

Provided herein are internal reflection elements (IRE) for attenuated total reflectance (ATR) spectroscopy, accessories including the IREs for Fourier Transform Infrared (FTIR) spectrometers and related methods.

Certain aspects of the invention are based, at least in part, on the inventors' discovery that at least some of the diverging rays of an IR beam directed onto certain IREs are not totally internally reflected at the interface between the IRE and the sample and contribute to poorer quality IR spectra. The inventors have further found that a layer of a reflective material coated onto a surface of these IREs, the layer defining a suitably configured entrance aperture for blocking a fraction of an IR beam directed at the IRE, can significantly and surprisingly increase the energy throughput of the IRE and improve the quality of the resulting IR spectrum. Additional benefits of at least some of the disclosed IREs include ease of mechanical alignment in accessories for use in FTIR spectrometers and greater versatility with different brands of FTIR spectrometers.

In one aspect, IREs are provided which include a lens element having opposed first and second surfaces, the surfaces converging at the edges of the lens element, and a layer of a reflective material coated over the first surface. The layer defines an entrance aperture through which an IR beam enters into the lens element and an exit aperture through which the IR beam exits the lens element. The entrance aperture is configured to block a fraction of the IR beam from entering the lens element. Exemplary shapes for the first and second surfaces of the lens elements are described below.

Similarly, exemplary shapes, dimensions and positions of the entrance and exit apertures are described below. In some embodiments, the entrance aperture is configured to block different fractions (i.e., different rays) of an IR beam directed towards the IRE. Exemplary fractions are described below. In other embodiments, the entrance aperture is configured to block a fraction of an IR beam directed towards the IRE from entering the lens element of the IRE such that the rays of the IR beam that do enter the lens element each ultimately have angle of incidence at a sampling area on the lens element that is within a specified range. Exemplary ranges are described below. In some embodiments, the layer of reflective material or the IRE provides the IRE with increased energy throughput as compared to the same IRE without the layer of reflective material. Exemplary increased energy throughputs are described below.

In another aspect, accessories for use with FTIR spectrometers are also provided. The accessories include any of the disclosed IREs and a variety of other possible components.

In yet another aspect, methods for forming any of the disclosed IREs are provided.

Other principal features and advantages of the invention will become apparent to those skilled in the art upon review of the following drawings, the detailed description, the examples and the appended claims.

### BRIEF DESCRIPTION OF THE DRAWINGS

Illustrative embodiments of the invention will hereafter be described with reference to the accompanying drawings.

FIG. 1 is a schematic illustration of an infrared (IR) beam emanating from a point source.

FIG. 2 depicts an embodiment of the disclosed IREs.

FIG. 3 depicts an embodiment of the disclosed IREs having a layer of a reflective material on a first surface of the IRE, the layer defining rectangular entrance and exit apertures. The first surface of the IRE is shown in FIG. 3A. A cross-section of the IRE is shown in FIG. 3B.

FIG. 4 depicts an embodiment of the disclosed IREs having a layer of a reflective material on a first surface of the IRE, the layer defining circular entrance and exit apertures. The first surface of the IRE is shown in FIG. 4A. A cross-section of the IRE is shown in FIG. 4B.

FIG. 5 depicts an embodiment of the disclosed IREs having a layer of a reflective material on a first surface of the IRE, the layer defining elliptical entrance and exit apertures.

FIG. 6 shows the first surface of two comparative IREs (A and B) and the first surface of the IRE of FIG. 5 (C). The energy throughputs of the three IREs are shown in FIG. 6D.

### DETAILED DESCRIPTION

Provided herein are internal reflection elements (IRE) for attenuated total reflectance (ATR) spectroscopy, accessories including the IREs for use in Fourier Transform Infrared (FTIR) spectrometers and related methods.

Internal Reflection Elements (IREs)

The disclosed IREs include a lens element having opposed first and second surfaces, the surfaces converging at the edges of the lens element, and a layer of a reflective material coated over the first surface. The layer defines an entrance aperture through which an IR beam enters into the lens element and an exit aperture through which the IR beam exits the lens element. The entrance aperture is configured to block a fraction of the IR beam from entering the lens element.

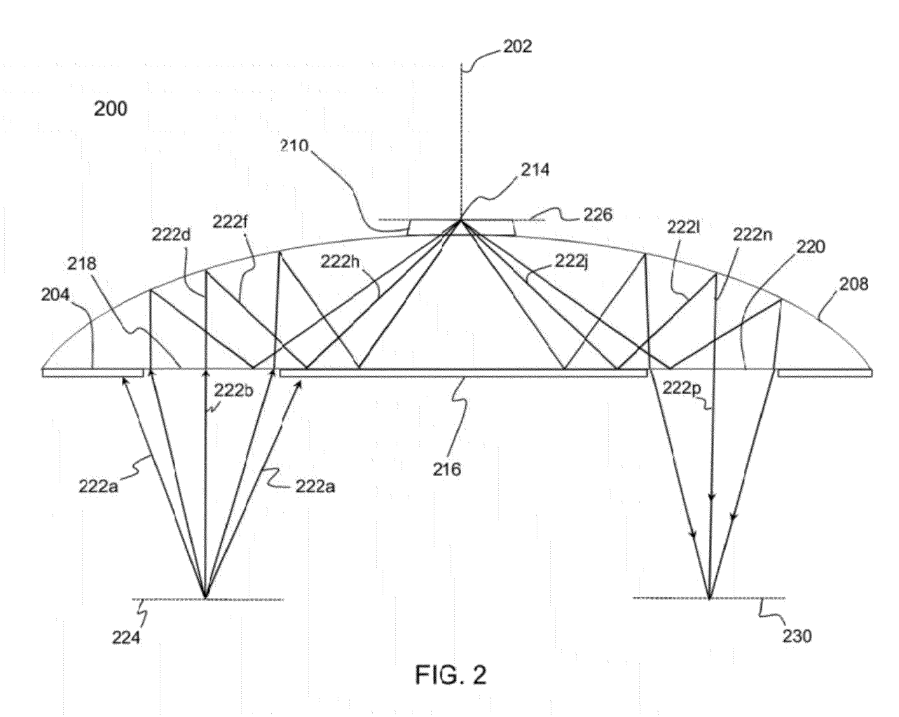

The first and second surfaces of the lens element of the IRE are shaped to focus that fraction of the IR beam passing through the entrance aperture onto a sampling area against which a sample may be placed and to refocus the IR beam as it exits the lens element through the exit aperture. In particular, a first portion of the first surface is shaped to refract the IR beam towards a first portion of the second surface. The first portion of the second surface is shaped to reflect the IR beam towards a second portion of the first surface. The second portion of the first surface is shaped to reflect the IR beam towards a sampling area on the second surface. The sampling area is shaped to reflect the IR beam towards a third portion of the first surface. The third portion of the first surface is shaped to reflect the IR beam towards a second portion of the second surface. The second portion of the second surface is shaped to reflect the IR beam towards a fourth portion of the first surface. The fourth portion of the first surface is shaped to refract the IR beam as it exits the lens element through the exit aperture. Specific, exemplary shapes for the first and second surfaces are shown in FIGS. 2-4 and are further discussed below. However, any of the shapes described in U.S. Pat. No. 5,965,889 may also be used. Standard optical techniques may be used for forming the lens elements of the IREs. For example, a diamond turning lathe may be used to shape the surfaces of the lens elements.

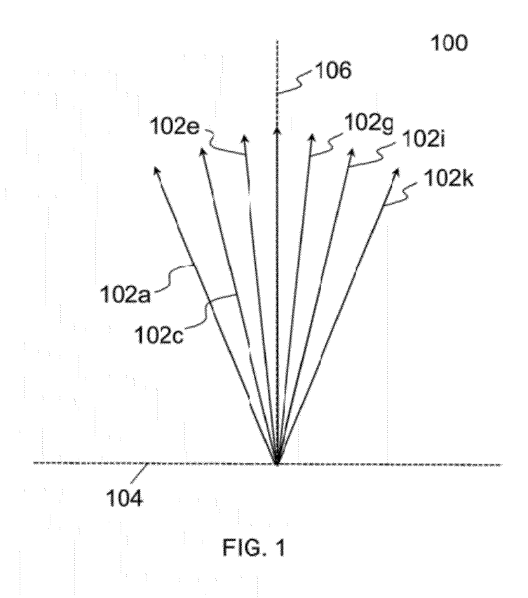

As noted above, the disclosed IREs include a layer of a reflective material coated over the first surface of the lens element of the IRE, the layer defining an entrance aperture configured to block a fraction of an IR beam directed towards the IRE from entering the lens element. An IR beam directed onto the IRE may be described as a bundle of light rays diverging from a point source as illustrated in FIG. 1. As shown in the figure, the IR beam 100 is represented as a bundle of light rays 102a-k diverging from a point source located at an image plane 104. The axis 106 is perpendicular to the image plane 104. Although only those light rays in the plane of the figure are shown, the IR beam is radially symmetric about axis 106. The inventors have found that some of these diverging rays entering the lens elements described above may ultimately strike the interface between the lens element and a sample on the lens element at angles less than the critical angle. The critical angle, θ_{c}, is given by Equation 1, below, where n₁ is the refractive index of the lens element and n₂ is the refractive index of the sample.

$${θ}_{c} = {sin}^{- 1} \frac{{n}_{2}}{{n}_{1}} \qquad Equation 1$$

The critical angle is defined with respect to an axis perpendicular to the interface of the lens element and sample. As a result, some of the IR beam will be refracted through the sample instead of being reflected out of the IRE to the detector, thereby resulting in poor quality IR spectra, including shifted baselines, asymmetric absorbance bands and low signal-to-noise values.

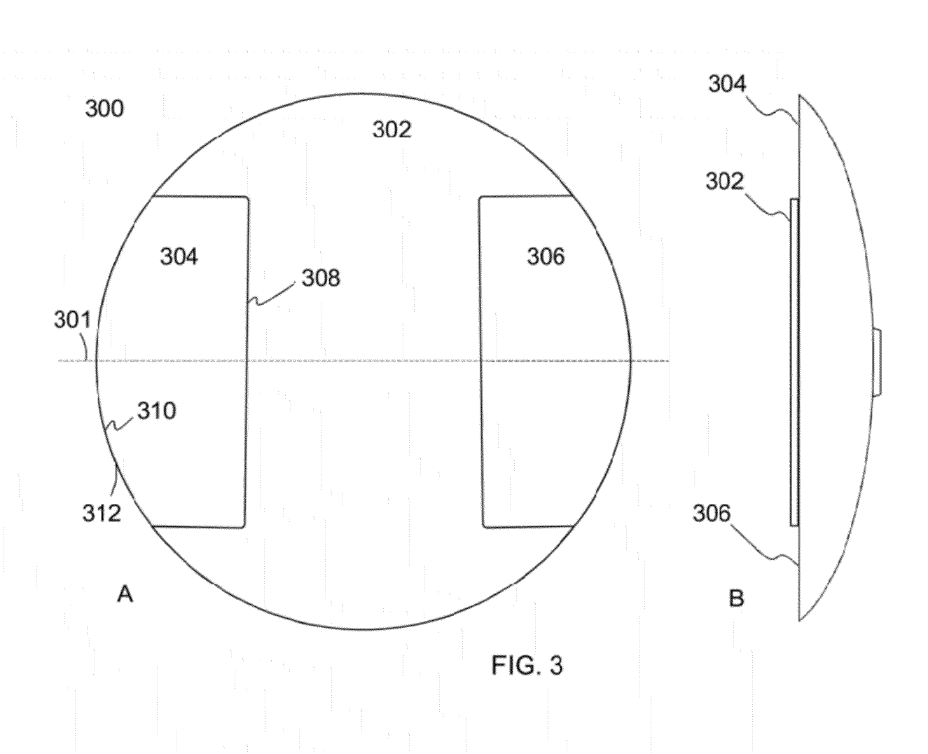

In the disclosed IREs, the shape, dimensions and position of the entrance aperture over the first surface of the lens element are such that at least some of the diverging rays of an IR beam directed towards the IRE are blocked from entering the lens element, thereby preventing or minimizing the problems associated with certain diverging rays. Various configurations of the entrance aperture are possible in which the shape, dimensions and position of the entrance aperture over the first surface of the lens element are such that different fractions (i.e., different rays) of an IR beam directed towards the IRE are blocked. With reference to FIG. 1, in some embodiments, the entrance aperture is configured such that those rays of the IR beam directed towards the IRE having the greatest angles of divergence (e.g., rays 102a and 102k) are blocked from entering the lens element of the IRE. In other embodiments, the entrance aperture is configured such that only some of the rays to the right of axis 106 (e.g., rays 102i and 102k) are blocked, while the rays on left of axis 106 (e.g., rays 102a-e) are not blocked. In still other embodiments, the entrance aperture is configured such that rays on both sides of the axis 106 are blocked, but more of the rays are blocked on one side of axis than the other. Specific, exemplary shapes, dimensions and positions of entrance apertures over the first surface of the lens element of an IRE are shown in FIGS. 3-5 and are further discussed below.

In some embodiments, the entrance aperture is configured to block a fraction of an IR beam directed towards the IRE from entering the lens element of the IRE such that the rays of the IR beam that do enter the lens element each ultimately have an angle of incidence at the sampling area that is no more than 6 degrees less than the critical angle of the lens element. This includes embodiments in which the rays have an angle of incidence that is no more than 5 degrees less, no more than 4 degrees less, no more than 3 degrees less, no more than 2 degrees less, or no more than 1 degree less than the critical angle of the lens element.

In other embodiments, the entrance aperture is configured such that the rays each have an angle of incidence at the sampling area that is greater than or equal to the critical angle of the lens element.

In still further embodiments, the entrance aperture is configured such that the rays each have an angle of incidence at the sampling area that is at least 1 degree greater than the critical angle of the lens element. This includes embodiments in which the rays have an angle of incidence that is at least 2 degrees greater, at least 3 degrees greater, at least 4 degrees greater, at least 5 degrees greater, or at least 6 degrees greater than the critical angle of the lens element.

In yet further embodiments, the entrance aperture is configured such that the rays each have an angle of incidence at the sampling area that is from 1 degree to 6 degrees greater than the critical angle of the lens element. This includes embodiments in which the rays have an angle of incidence that is from 1 to 5 degrees, from 1 to 4 degrees, from 1 to 3 degrees, from 1 to 2 degrees, from 2 to 6 degrees, from 3 to 6 degrees, from 4 to 6 degrees, from 5 to 6 degrees, or from 2 to 4 degrees greater than the critical angle of the lens element.

Configurations which provide the angles of incidence described above may be determined through the use of commercially available ray tracing programs.

As noted above, the layer of reflective material coated over the first surface of the disclosed IREs also defines an exit aperture through which the IR beam exits the lens element of the IRE. The exit aperture may assume a variety of shapes, sizes and positions over the first surface provided that at least some of the rays of IR beam that entered the lens element are able to exit the lens element. In some embodiments, the exit aperture has the same shape and size as the entrance aperture. In other embodiments, the exit aperture and the entrance aperture are symmetrically positioned over the first surface of the lens element. In still other embodiments, the entrance aperture and the exit aperture have the same shape and size and are symmetrically positioned over the first surface of the lens element.

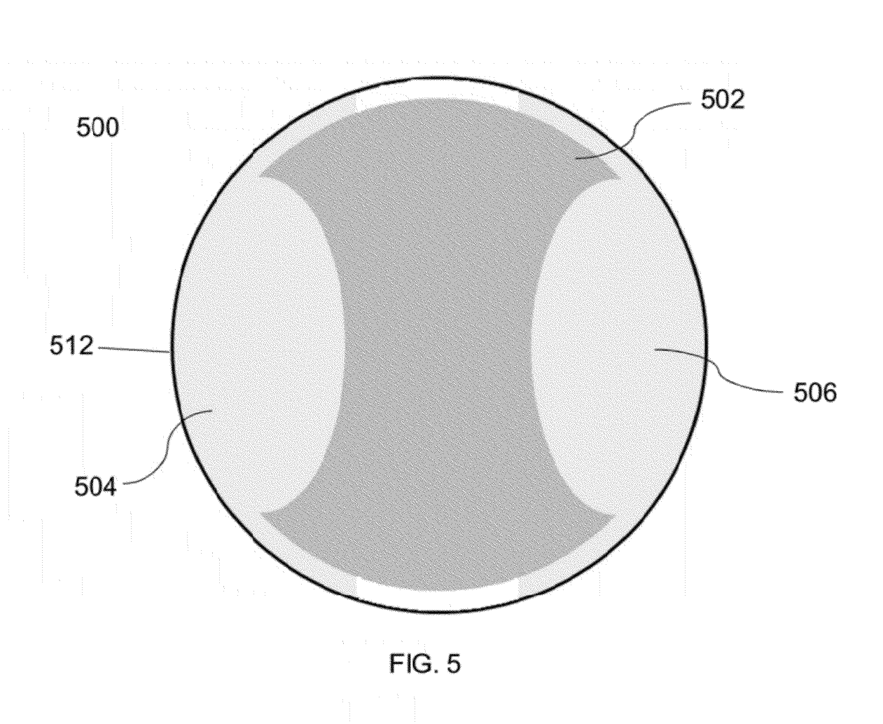

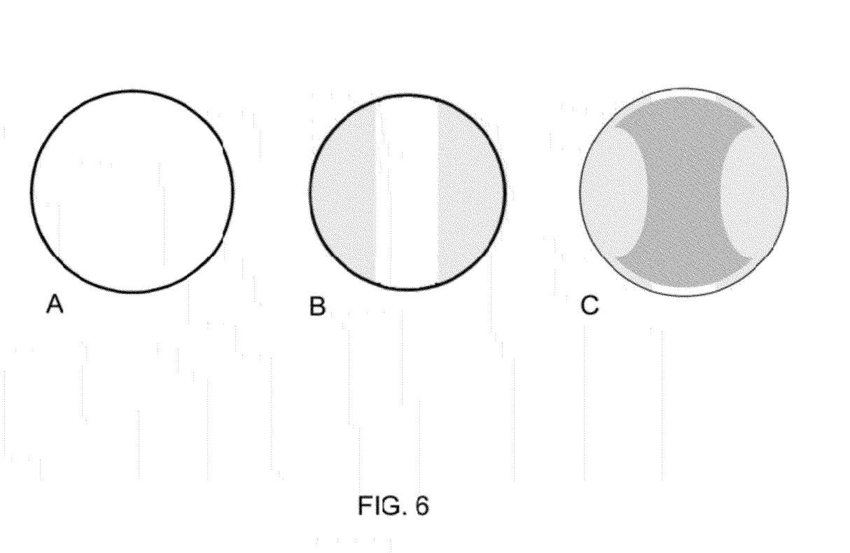

The coverage of the layer of reflective material over the first surface of the lens element of the IREs may vary. In some embodiments, the layer covers the second portion of the first surface (i.e., that portion of the first surface which is shaped to reflect the IR beam towards the sampling area) and the third portion of the first surface (i.e., that portion of the first surface which receives the reflected IR beam from the sampling area and is shaped to reflect the IR beam towards the second portion of the second surface). The inventors have found that the presence of the layer over these portions may serve to enhance the reflection of the IR beam at each portion, thereby ensuring that as much as possible of the energy of IR beam passing through the lens element exits the lens element. In other embodiments, the layer covers substantially all of the first surface except for those portions of the first surface exposed by the entrance aperture and the exit aperture. By substantially it is meant that coverage of the layer is as complete over the first surface (except for the entrance and exit apertures) as is possible using standard techniques for coating optical surfaces with reflective materials. The coverage may not necessarily perfectly complete. Moreover, the perimeter of the first surface of the IRE need not be covered with the layer of reflective material and the layer may still be said to cover substantially all of the first surface except for those portions of the first surface exposed by the entrance aperture and the exit aperture (See, e.g., FIG. 5).

The disclosed IREs may be characterized by their energy throughput. The energy throughput of an IRE may be measured by collecting a spectrum of the IRE ratioed to the open beam FTIR background spectrum. Energy throughputs may be reported as the % Transmission at a particular wavelength of light. Low energy throughputs can contribute to poor quality IR spectra, including shifted baselines, asymmetric absorbance bands and low signal-to-noise values. Even small increases in energy throughput can significantly improve the quality of IR spectra. The inventors have found that at least some embodiments of the disclosed IREs have significantly greater energy throughputs than the same IREs without the layer of a reflective material coated over the first surface of the lens element of the IRE. Thus, in some embodiments, the IRE exhibits an energy throughput that is greater than the IRE without the layer of a reflective material coated over the first surface of the lens element. In some embodiments, the energy throughput of the IRE is greater than the IRE without the layer of a reflective material over the region ranging from 3500 cm⁻¹ to 1000 cm⁻¹, which is a region of interest in many mid-IR spectroscopy applications. In such embodiments, the energy throughput of the IRE is greater over this entire region. This includes embodiments in which the energy throughput is greater over the region ranging from 3500 cm⁻¹ to 1500 cm⁻¹, 3500 cm⁻¹ to 2000 cm⁻¹, 3500 cm⁻¹ to 2500 cm⁻¹, 3000 cm⁻¹ to 1000 cm⁻¹, 2500 cm⁻¹ to 1000 cm⁻¹, 2000 cm⁻¹ to 1000 cm⁻¹, 3000 cm⁻¹ to 1500 cm⁻¹ or 2500 cm⁻¹ to 2000 cm⁻¹.

In other embodiments, the IRE exhibits an average energy throughput over the region from 3500 cm⁻¹ to 1000 cm⁻¹ that is at least 2% greater than the IRE without the layer of a reflective material coated over the first surface of the lens element. This includes embodiments in which the IRE exhibits an average energy throughput that is at least 4% greater, 6% greater, 8% greater, 10% greater, 12% greater, 14% greater, 16% greater, 18% greater or even higher.

In other embodiments, the IRE exhibits an energy throughput at 1200 cm⁻¹ that is at least 2% greater than the IRE without the layer of a reflective material coated over the first surface of the lens element. This includes embodiments in which the IRE exhibits an energy throughput that is at least 4% greater, 6% greater, 8% greater, 10% greater, 12% greater, 14% greater, 16% greater, 18% greater, 20% greater or even higher.

These increased energy throughputs are surprising since the entrance aperture is configured to block some light of the IR beam that, prior to the inventors' discovery of the problem of diverging rays, would have thought to have been available for interacting with the sample.

The reflective material used to form the layer over the first surface may vary, provided the material is capable of reflecting infrared radiation. An exemplary, suitable reflective material is aluminum. Similarly, the thickness of the layer may vary. In some embodiments, the thickness ranges from 1 to 2 μm. Standard techniques for coating optical surfaces with reflective materials may be used to form the layer of reflective material over the first surface of the lens elements. For example, physical vapor deposition may be used.

The disclosed IREs may include other layers of other materials coated over the first and/or second surfaces. In some embodiments, the IRE further includes a layer of an antireflective material coated over the first portion of the first surface (i.e., that portion of the first surface which receives the IR beam passed through the entrance aperture and is shaped to refract the IR beam towards a first portion of the second surface) and the fourth portion of the first surface (i.e., that portion of the first surface which is shaped to refract the IR beam exiting out of the lens element of the IRE through the exit aperture). Suitable antireflective materials are known and standard techniques for coating optical surfaces with such materials may be used. For example, physical vapor deposition may be used.

A variety of crystal materials may be used to form the lens element of the IREs, provided the material is optically transparent to infrared radiation. An exemplary suitable material is zinc selenide (ZnSe). Other suitable materials are described in U.S. Pat. No. 5,965,889.

One embodiment of the disclosed IREs is shown in FIG. 2. The IRE 200 is radially symmetric about an axis 202. The IRE includes a lens element having a first surface 204 and second surface 208 opposite to the first surface. The first surface is planar and the second surface is convex such that the surfaces converge at the edges of the lens element. The second surface includes a raised plateau 210 centered along the axis 202. The surface of the raised plateau provides a sampling area 214 against which a sample may be placed.

The IRE 200 includes a layer of a reflective material 216 coated on the first surface 204. The layer defines an entrance aperture 218 and an exit aperture 220. The entrance aperture is configured to block a fraction of an IR beam emanating from an image plane 224 from entering the lens element of the IRE. Specifically, the shape, dimensions and position of the entrance aperture over the first surface are such that the rays 222a of the IR beam are blocked from entering the lens element. As further discussed below, the first and second surfaces of the lens element are shaped to focus those rays 222b that are not blocked and pass through the entrance aperture onto an image plane 226 at a sampling area 214 on the second surface 208 of the lens element and to refocus the IR beam reflecting off the sampling area onto an image plane 230.

Those rays 222b of the IR beam that are not blocked by the entrance aperture 218 enter the lens element through a first portion of the first surface 204. The first portion of the first surface is shaped to refract the rays 222b to form rays 222d passing through the lens element towards a first portion of the second surface 208. The first portion of the second surface is shaped to reflect the rays 222d to form rays 222f passing through the lens element towards a second portion of the first surface. The second portion of the first surface is shaped to reflect the rays 222f to form rays 222h passing through the lens element towards the sampling area 214 on the second surface. The shapes of the surfaces through which rays 222b are refracted and rays 222d and 222f are reflected are such that bring the IR beam into focus at image plane 226 at the sampling area 214.

The surface of the raised plateau 210 which provides the sampling area 214 is perpendicular to axis 202. Rays 222h are reflected to form rays 222j passing through the lens element towards a third portion of the first surface 204. The third portion of the first surface is shaped to reflect the rays 222j to form rays 222l passing through the lens element towards a second portion of the second surface 208. The second portion of the second surface is shaped to reflect the rays 222l to form rays 222n passing through the lens element towards a fourth portion of the first surface. The fourth portion of the first surface is shaped to refract the rays 222n to form rays 222p exiting out of the lens element through the exit aperture 220. The shapes of the surfaces through which rays 222j and 222l are reflected and rays 222n are refracted are such that bring the IR beam back into focus at image plane 230.

Specific, exemplary configurations of entrance and exit apertures are shown in FIGS. 3-5. FIG. 3A shows the front surface of an IRE 300. A cross-section of the IRE taken along the axis 301 is shown in FIG. 3B. The front surface of the lens element of the IRE is coated with a layer 302 of a reflective material. The layer defines an entrance aperture 304 and an exit aperture 306. The entrance aperture is rectangular in shape and has a vertical side 308 and an opposing side 310 formed by the edge 312 of the lens element. The exit aperture has the same shape and dimensions as the entrance aperture and the apertures are symmetrically positioned over the first surface. The IRE may also include a layer (not shown) of an antireflective material coated over those portions of the front surface of the lens element exposed by the entrance and exit apertures.

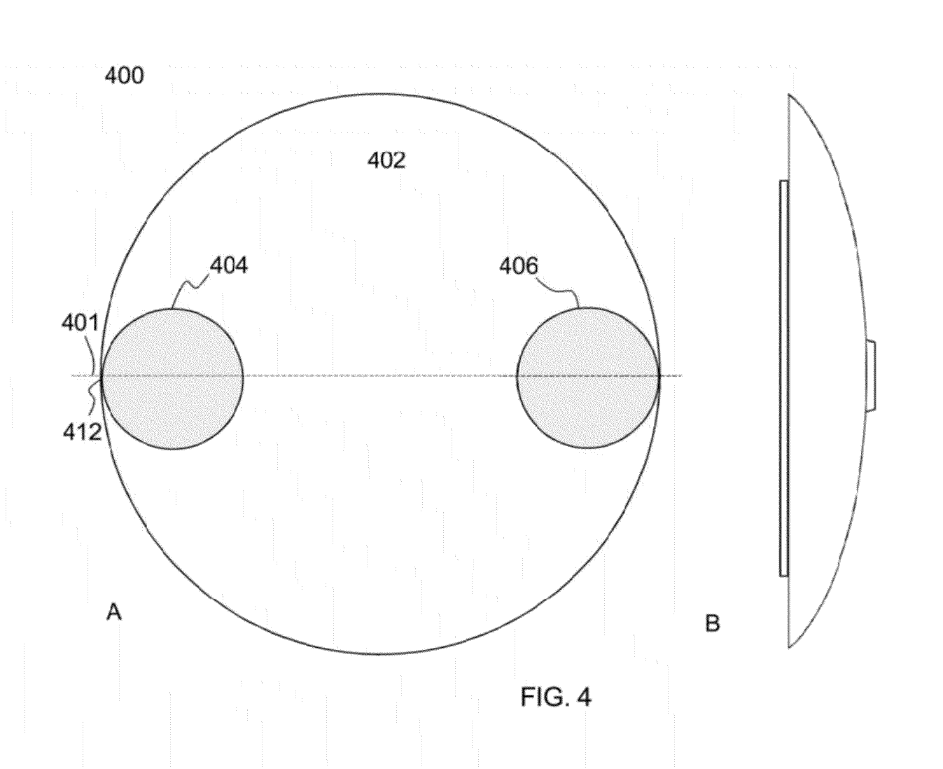

FIG. 4A shows the front surface of an IRE 400. A cross-section of the IRE taken along axis 401 is shown in FIG. 4B. The front surface of the lens element of the IRE is coated with a layer 402 of a reflective material. The layer defines an entrance aperture 404 and an exit aperture 406. The entrance aperture is circular in shape and has an edge in contact with the edge 412 of the lens element. The exit aperture has the same shape and dimensions as the entrance aperture and the apertures are symmetrically positioned over the first surface. The IRE also includes a layer (shown with shading) of an antireflective material coated over those portions of the front surface of the lens element exposed by the entrance and exit apertures.

FIG. 5 shows the front surface of an IRE 500. The front surface of the lens element of the IRE is coated with a layer 502 of a reflective material. The layer defines an entrance aperture 504 and an exit aperture 506. The entrance aperture is elliptical in shape and has an edge in contact with the edge 512 of the lens element. The exit aperture has the same shape and dimensions as the entrance aperture and the apertures are symmetrically positioned over the first surface. The IRE also includes a layer (shown with shading) of an antireflective material coated over those portions of the front surface of the lens element exposed by the entrance and exit apertures. The diameter of the IRE shown in FIG. 5 is 32 mm; the length of the major diameter of the elliptical apertures is 18 mm; and the length of the minor diameter of the elliptical apertures is 7.6 mm.

Accessories

Also provided are accessories for use with Fourier Transform Infrared (FTIR) spectrometers. The accessories include any of the IREs disclosed herein and a mounting assembly, the mounting assembly including a body defining a cavity configured to accommodate the IRE. A surface of the body may define an aperture through which the sampling area of the IRE is exposed. The mounting assembly and/or accessories can include a variety of other components, e.g., components for retaining the IRE within the cavity of the body of the mounting assembly (e.g., washers, spacers, or retaining plates); components for protecting the exposed sampling area (e.g., protective plates); components for holding samples against the IRE (e.g., adapter plates for liquid samples or anvils for compressing samples); and components for coupling the mounting assembly to the FTIR (e.g., optics for directing an IR beam towards the IRE and optics for directing the IR beam exiting the IRE towards a detector). Any of the components described in U.S. Pat. No. 5,965,889 may be used.

It is noted that, in some embodiments, the layer of reflective material on the first surface of any of the disclosed lens elements provides an aperture system for an IR beam in addition to one or more aperture systems that may be included with an accessory for use with an FTIR spectrometer and/or the FTIR spectrometer itself. Thus, in such embodiments, the layer provides a first aperture system and the accessory and/or FTIR spectrometer includes a second, third, etc. aperture system.

Methods

Also provided are methods for forming any of the disclosed IREs. In one embodiment, the method includes coating a layer of reflective material on the first surface of a lens element, the layer defining an entrance aperture configured to block a fraction of an IR beam from entering the lens element and an exit aperture through which the IR beam exits the lens element. Any of the lens elements disclosed above may be used. Similarly, the layer may define any of the entrance apertures and exit apertures disclosed above. As noted above, standard techniques for coating reflective materials onto optics may be used.

In another embodiment, the method further includes forming the lens element. As noted above, standard techniques for shaping optical materials may be used.

The IREs will be understood more readily by reference to the following examples, which are provided by way of illustration and are not intended to be limiting.

### EXAMPLES

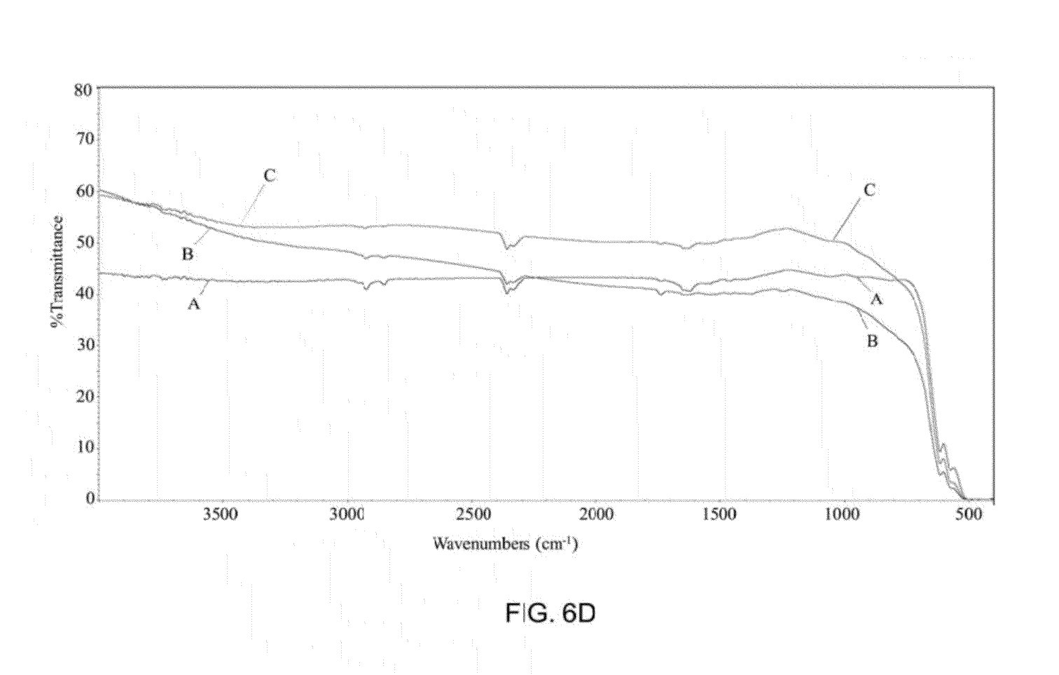

Internal reflection elements (IRE) were formed by coating layers of antireflective material and/or reflective material onto ZnSe lens elements (Pike Technologies P/N 025-2018) using physical vapor deposition. The cross-sections of these lens elements were similar to those shown in FIGS. 2-4. The first surface of each of the three IREs is shown in FIG. 6A-C. A first IRE (A) was composed of the ZnSe lens element only. No layers of antireflective material or reflective material were coated over the first surface. A second IRE (B) was composed of the ZnSe lens element and a layer of an antireflective material coated over those portions of the first surface through which the IR beam enters and exits (shown with shading). No layer of reflective material was coated over the first surface. A third IRE (C) was composed of the ZnSe lens element having the same layer of an antireflective material coated over the first surface as the second IRE (shown with light shading). In addition, the third IRE included a layer of aluminum (shown with dark shading) defining an elliptical entrance aperture and an elliptical exit aperture.

Each IRE was secured into an accessory (Pike Technologies P/N 025-1851) using a retaining plate held against the first surface of the IRE. The first IRE used a circular retaining plate having a rectangular shaped aperture through which the IR beam entered and a rectangular shaped aperture through which the IR beam exited. Thus, the apertures of this circular retaining plate were similar in configuration to the entrance and exit apertures defined by the layer of reflective material of the third IRE. The second and third IREs were secured using circular retaining plates having a large, circular shaped central aperture through which the IR beam passed unobscured.

Accessories were mounted into a Bruker Tensor 27 Interferometer. Energy throughputs (% Transmission versus wavenumber) for each IRE were measured by collecting a spectrum of the IRE mounted in the accessory ratioed to the open beam FTIR background spectrum. The settings of the FTIR were as follows: 8 cm⁻¹ resolution; 10 scans from 5000-400 cm⁻¹; transmittance mode; and 6 mm aperture. The optics of the accessory were adjusted to maximize energy throughput for each IRE prior to collecting spectra.

The energy throughputs of the three IREs are shown in FIG. 6D: curve A (the first IRE); curve B (the second IRE); and curve C (the third IRE). The results show that the energy throughput of curve C is greater than the energy throughput of curves A and B over the region from 3500 to 1000 cm⁻¹. In addition, the average energy throughput of curve C over this region is 8% greater than curve A and 6% greater than curve B over the same region. Finally, the energy throughput of curve C at 1200 cm⁻¹ is 7% greater than curve A and 11% greater than curve B at 1200 cm⁻¹. These results establish that the third IRE (an embodiment of the invention described herein) is capable of providing surprisingly superior energy throughputs as compared to the same IRE without the layer of a reflective material coated over the first surface of the lens element. The energy throughput of the third IRE is also surprisingly superior to the IRE having no layer of a reflective material but which is secured in the FTIR accessory with a retaining plate having rectangular shaped entrance and exit apertures.

The word “illustrative” or “exemplary” is used herein to mean serving as an example, instance, or illustration. Any aspect or design described herein as “illustrative” or “exemplary” is not necessarily to be construed as preferred or advantageous over other aspects or designs. Further, for the purposes of this disclosure and unless otherwise specified, “a” or “an” means “one or more”. Still further, the use of “and” or “or” is intended to include “and/or” unless specifically indicated otherwise.

All patents, applications, references, and publications cited herein are incorporated by reference in their entirety to the same extent as if they were individually incorporated by reference.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art, all language such as “up to,” “at least,” “greater than,” “less than,” and the like includes the number recited and refers to ranges which can be subsequently broken down into subranges as discussed above. Finally, as will be understood by one skilled in the art, a range includes each individual member.

The foregoing description of illustrative embodiments of the invention have been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. An internal reflection element (IRE) for attenuated total reflectance spectroscopy with an IR beam, the IRE comprising a lens element having opposed first and second surfaces converging at edges of the lens element and a layer of a reflective material coated over the first surface,
wherein the layer defines an entrance aperture configured to block a fraction of an IR beam from entering the lens element and an exit aperture through which the IR beam exits the lens element,
and further wherein,
a) a first portion of the first surface is shaped to refract the IR beam entering the lens element via the entrance aperture towards a first portion of the second surface;
b) the first portion of the second surface is shaped to reflect the IR beam towards a second portion of the first surface;
c) the second portion of the first surface is shaped to reflect the IR beam towards a sampling area on the second surface;
d) the sampling area is shaped to reflect the IR beam towards a third portion of the first surface;
e) the third portion of the first surface is shaped to reflect the IR beam towards a second portion of the second surface;
f) the second portion of the second surface is shaped to reflect the IR beam towards a fourth portion of the first surface; and
g) the fourth portion of the first surface is shaped to refract the IR beam exiting the lens element via the exit aperture.

2. The IRE of claim 1, wherein the entrance aperture is configured such that rays of the IR beam entering the lens element strike the sampling area with an angle of incidence that is greater than the critical angle of the lens element.

3. The IRE of claim 1, wherein the entrance aperture is configured such that rays of the IR beam entering the lens element strike the sampling area with an angle of incidence that is from 1 to 6 degrees greater than the critical angle of the lens element.

4. The IRE of claim 1, wherein the entrance aperture is positioned along an edge of the lens element such that an edge of the entrance aperture is in contact with the edge of the lens element.

5. The IRE of claim 4, wherein the entrance aperture is rectangular having a vertical side and an opposing side formed by the edge of the lens element.

6. The IRE of claim 4, wherein the entrance aperture is circular.

7. The IRE of claim 4, wherein the entrance aperture is elliptical.

8. The IRE of claim 1, wherein the second portion and the third portion of the first surface are coated by the layer.

9. The IRE of claim 1, wherein the layer provides an energy throughput over the region from 3500 cm⁻¹ to 1000 cm⁻¹ that is greater than the energy throughout of the IRE without the layer.

10. The IRE of claim 1, wherein the layer provides an average energy throughput over the region from 3500 cm⁻¹ to 1000 cm⁻¹ that is at least 2% greater than the energy throughput of the IRE without the layer.

11. The IRE of claim 1, wherein the layer provides an energy throughput at 1200 cm⁻¹ that is at least 2% greater than the energy throughout of the IRE without the layer.

12. An internal reflection element (IRE) for attenuated total reflectance spectroscopy with an IR beam, the IRE comprising a lens element having opposed first and second surfaces converging at edges of the lens element and a layer of a reflective material coated over the first surface,
wherein the layer defines an entrance aperture configured to block a fraction of an IR beam from entering the lens element and an exit aperture through which the IR beam exits the lens element,
further wherein,
a) a first portion of the first surface is shaped to refract the IR beam entering the lens element via the entrance aperture towards a first portion of the second surface;
b) the first portion of the second surface is shaped to reflect the IR beam towards a second portion of the first surface;
c) the second portion of the first surface is shaped to reflect the IR beam towards a sampling area on the second surface;
d) the sampling area is shaped to reflect the IR beam towards a third portion of the first surface;
e) the third portion of the first surface is shaped to reflect the IR beam towards a second portion of the second surface;
f) the second portion of the second surface is shaped to reflect the IR beam towards a fourth portion of the first surface; and
g) the fourth portion of the first surface is shaped to refract the IR beam exiting the lens element via the exit aperture,
and further wherein the entrance aperture and exit aperture are each elliptical, each having an edge in contact with the edge of the lens element.

13. The IRE of claim 12, wherein the entrance aperture is configured such that rays of the IR beam entering the lens element strike the sampling area with an angle of incidence that is from 1 to 6 degrees greater than the critical angle of the lens element.

14. The IRE of claim 12, wherein the second portion and the third portion of the first surface are coated by the layer.

15. The IRE of claim 12, wherein the layer provides an energy throughput over the region from 3500 cm⁻¹ to 1000 cm⁻¹ that is greater than the energy throughout of the IRE without the layer.

16. The IRE of claim 12, wherein the layer provides an energy throughput at 1200 cm⁻¹ that is at least 2% greater than the energy throughout of the IRE without the layer.

17. The IRE of claim 12, wherein the reflective material is aluminum and the IRE further comprises a layer of an antireflective material coated over the first portion and a layer of an antireflective material coated over the fourth portion.

18. An accessory for a Fourier Transform Infrared spectrometer, the accessory comprising:
a) an internal reflection element (IRE) for attenuated total reflectance spectroscopy with an IR beam, the IRE comprising a lens element having opposed first and second surfaces converging at edges of the lens element and a layer of a reflective material coated over the first surface,
wherein the layer defines an entrance aperture configured to block a fraction of an IR beam from entering the lens element and an exit aperture through which the IR beam exits the lens element,
and further wherein,
i) a first portion of the first surface is shaped to refract the IR beam entering the lens element via the entrance aperture towards a first portion of the second surface;
ii) the first portion of the second surface is shaped to reflect the IR beam towards a second portion of the first surface;
iii) the second portion of the first surface is shaped to reflect the IR beam towards a sampling area on the second surface;
iv) the sampling area is shaped to reflect the IR beam towards a third portion of the first surface;
v) the third portion of the first surface is shaped to reflect the IR beam towards a second portion of the second surface;
vi) the second portion of the second surface is shaped to reflect the IR beam towards a fourth portion of the first surface; and
vii) the fourth portion of the first surface is shaped to refract the IR beam exiting the lens element via the exit aperture; and
b) a mounting assembly comprising a body having a cavity configured to accommodate the IRE.

19. A method for forming the IRE of claim 1, the method comprising coating the layer of the reflective material on the first surface of the lens element.

20. The method of claim 19, further comprising forming the lens element prior to the coating step.
